(19) United States
(12) Patent Application Publication
(10) Pub. No.: US 2015/0119524 A1
(43) Pub. Date: Apr. 30, 2015

(54) ANTIFOAMING AGENT FOR NONAQUEOUS COATING AGENTS

(71) Applicant: KYOEISHA CHEMICAL CO., LTD., Osaka-shi, Osaka (JP)

(72) Inventors: Daisuke Mitomi, Nara-shi (JP); Yuusuke Sainouchi, Nara-shi (JP); Yousuke Kataoka, Nara-shi (JP)

(73) Assignee: KYOEISHA CHEMICAL CO., LTD., Osaka-shi, Osaka (JP)

(21) Appl. No.: 14/396,534

(22) PCT Filed: Apr. 25, 2013
(86) PCT No.: PCT/JP2013/062232

§ 371 Date: Oct. 23, 2014

(30) Foreign Application Priority Data
Apr. 27, 2012 (JP) 2012-103107

(51) Int. Cl. C08F 26/10; C08F 22/10; C09D 133/14; C09D 139/06; C09D 137/00; C09D 133/26; C08F 24/00; C08F 22/38

(52) U.S. Cl. CPC C08F 26/10; C08F 24/00; C08F 22/10; C08F 22/38; C09D 139/06; C09D 137/00; C09D 133/26; C09D 133/14
USPC 524/549; 526/264; 526/270; 526/320; 526/307.5; 524/548; 524/555; 524/558

(57) ABSTRACT

Provided is an antifoaming agent for a coating agent, which suppresses foaming of a coating agent by being blended into a nonaqueous agent in a small amount, thereby improving pinhole preventing performance, and which may form a thermo-setting coating film or a thermo-drying coating film having an excellent aesthetic appearance by suppressing the generation of pinholes without deteriorating smoothing performance of the coating film even under conditions where pinholes are easily generated. The antifoaming agent for the nonaqueous agent comprises a copolymerization product having a weight-molecular weight of 10,000-350,000, which is copolymerized with 2-40 parts by weight of a hydrophilic monomer at least of one selected form the group consisting of: an N-vinyl lactam monomer; tetrahydrofurfuryl (meth)acrylate monomer; a (meth)acrylate monomer; a (meth)acrylamide monomer; and a hydroxyalkyl (meth)acrylate monomer, and 60-98 parts by weight of an alkyl (meth)acrylate having an alkyl group and/or a hydrophobic monomer of vinyl ether having an alkyl group.

### TECHNICAL FIELD

The present invention relates to an antifoaming agent which is blended into a nonaqueous coating agent, suppresses foaming thereof, and provides pinhole prevention on a surface of a coating film formed by applying thereof.

### BACKGROUND OF THE ART

A base material such as plastic materials, pre-coat metals, building materials and bodies of automobiles are conducted a coating treatment using a coating agent such as baking paint or a varnish compound for the purpose of protection of the surface thereof and improvement of an aesthetic appearance thereof. The coating agent is applied onto the surface of the base material and treated with heat. Thereby, a thermosetting resin contained thereinto is cured, or a solvent contained within a thermoplastic resin having a high glass-transition point is dried. Then, the coating agent forms a coating film.

Generally, an antifoaming agent, which is also called as a pinhole prevention agent, is added into the coating agent in order to provide antifoaming performance which suppresses foaming of the coating agent, and pinhole preventing performance to prevent pinhole generated by rapid heating at the time of baking.

As a compound employed for the antifoaming agent, for example, poly(meth)acrylate, polyvinyl ether, a their copolymerization product, a modified polybutadiene, an olefinic copolymerization product, and a modified polydimethyl siloxane product are known.

Further, as a compound to which the compound employed for the antifoaming agent and an antifoaming agent which contains them, for example, an antifoaming agent which is a reactive monomer having an isocyanate group or a copolymerization product of a reactive monomer having a functional group derived from the isocyanate group is disclosed in Patent Document 1. Additionally, a surface conditioner including a copolymerization product is disclosed in Patent Document 2, wherein the copolymerization product has a cross-linking reaction active functional group and a cross-linking reaction inductive functional group which reacts therewith, and forms a cross-linking between molecules thereby. The surface conditioner is added into a composition for a thermo-setting coating film forming, and provides antifoaming performance, pinhole preventing performance, and smoothing performance.

The nonaqueous coating agent of the thermo-setting type and/or the thermo-drying type, in which the conventional antifoaming agent is added, may suppress side effects such as water-whitening resistance and volatile oil resistance of an applied film.

However, in order to foreshorten a paint process line for the purpose of recent energy saving, at wide temperature range from low temperature to high temperature, further improvement of antifoaming performance and pinhole preventing performance as basic performance of the antifoaming agent is desired.

### PRIOR ART DOCUMENT

### Patent Document

[Patent Document 1] JP Patent Application Publication No. 2002-066206A
[Patent Document 2] JP Patent Application Publication No. 2005-290128A

### SUMMARY OF THE INVENTION

### Problems to be Solved by the Invention

The present invention was made in the view of solving the above descried problems, its object is to provide an antifoaming agent for a nonaqueous coating agent, which suppresses foaming of the coating agent by being blended thereinto in a small amount, thereby improving pinhole preventing performance, and which may form a thermo-setting and/or thermo-drying coating film having an excellent aesthetic appearance by suppressing the generation of pinholes without deteriorating smoothing performance of the coating film even under conditions where pinholes are easily generated, a nonaqueous coating agent into which the antifoaming agent is blended, and a coating film which is formed by applying the nonaqueous coating agent.

### Means for Solving Problems

As a result of various studies, the inventors of the present invention have found out that a polymerization product, which is obtained by copolymerization of a monomer employed for an antifoaming agent for a conventional paint and a monomer having comparatively-high polarity, has excellent antifoaming performance. Then, the present invention has been achieved.

An antifoaming agent for a nonaqueous coating agent of claim 1, which is developed to achieve the objects above described, comprises a copolymerization product having a weight-average molecular weight of 10,000-350,000, is copolymerized with; 2-40 parts by weight of a hydrophilic monomer at least one selected from the group consisting of: an N-vinyl lactam monomer; a tetrahydrofurfuryl (meth)acrylate monomer; a (meth)acrylate monomer represented by following Formula (I):

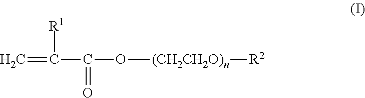

in Formula (I); R¹ is a hydrogen atom or a methyl group, R² is a hydrogen atom or an alkyl group having 1-4 carbon atoms, and n is a positive number of 2-3; a (meth)acrylamide monomer represented by following Formula (II):

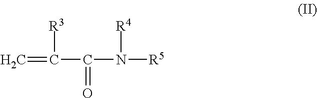

in Formula (II); R³ is a hydrogen atom or a methyl group, R⁴ is a hydrogen atom, a methyl group, or an ethyl group, R⁵ is a methyl group or an ethyl group; and a hydroxyalkyl (meth)acrylate monomer with an alkyl group having 2-4 carbon atoms, and 60-98 parts by weight of a hydrophobic monomer of an alkyl (meth)acrylate with an alkyl group having 8-22 carbon atoms and/or vinyl ether with an alkyl group having 8-18 carbon atoms.

In the antifoaming agent for a nonaqueous coating agent of claim 2 according to claim 1, the hydrophilic monomer is the N-vinyl lactam monomer at least one selected from the group consisting of N-vinyl-2-pyrrolidone and N-vinyl-ε-caprolactam; the (meth)acrylate monomer represented by Formula (I) whose R² is a methyl group, an ethyl group, a n-propyl group, an isopropyl group, a n-butyl group, an isobutyl group and/or a tert-butyl group; the (meth)acrylamide monomer at least one selected from the group consisting of N-methyl (meth)acrylamide, N-ethyl (meth)acrylamide, N,N-dimethyl (meth)acrylamide, and N,N-diethyl (meth)acrylamide; and/or the hydroxyalkyl (meth)acrylate monomer at least one selected from the group consisting of 2-hydroxyethyl (meth)acrylate, 2-hydroxypropyl (math)acrylate, 3-hydroxypropyl (meth)acrylate, 2-hydroxybuthyl (meth)acrylate, 3-hydroxybuthyl (meth)acrylate, 4-hydroxybuthyl (meth)acrylate, and 2-methyl-2-hydroxy propyl (meth)acrylate.

A nonaqueous coating agent of claim 3 comprises the antifoaming agent according to claim 1 or 2 and a nonaqueous coating constituent.

An applied film of claim 4 is formed by applying the nonaqueous coating agent according to claim 3.

### Effects of the Invention

An antifoaming agent of the present invention may be used by being blended into a nonaqueous coating agent of a thermo-setting type and/or thermo-drying type in a small amount. The antifoaming agent may suppress foaming of the nonaqueous coating agent by being added thereinto, and may exhibit excellent antifoaming performance and pinhole preventing performance compared with a conventional antifoaming agent.

The nonaqueous coating agent of the present invention suppresses its foaming, may form a coating film with excellent smoothness by thermo-setting and/or thermo-drying. When the nonaqueous coating agent is applied onto a base material and conducted thermo-setting and/or thermo-drying, even in thick film parts where easily generates pinholes, generation of pinholes may be suppressed. Therefore, an applied film having excellent smoothness without the pinholes may be obtained. Additionally, on the applied film which is formed by applying a nonaqueous coating agent onto a base material, a coating agent of same type or different type may be applied and the applied film may be formed without difference of adhesion between layers.

According to the applied film of the present invention, a surface thereof has excellent smoothness without pinholes, and aesthetic appearance of a surface thereof may be improved.

### MODE FOR CARRYING OUT THE INVENTION

Hereunder, embodiments to practice the present invention in detail will be explained, but the scope of the present invention is not restricted by these embodiments.

An antifoaming agent of the present invention includes a copolymerization product in which a hydrophilic monomer at least one selected from the group consisting of an N-vinyl lactam monomer (A1) such as N-vinyl-2-pyrrolidone; a tetrahydrofurfuryl (meth)acrylate monomer (A2); a (meth)acrylate monomer (A3) represented by following Formula (I):

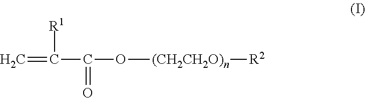

wherein, in Formula (I): R¹ is a hydrogen atom or a methyl group, R² is a hydrogen atom or an alkyl group having 1-4 carbon atoms, and n is a positive number of 2-3; a (meth)acrylamide monomer (A4) represented by following Formula (II):

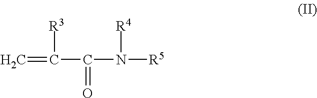

wherein, in Formula (II): R³ is a hydrogen atom or a methyl group, R⁴ is a hydrogen atom, a methyl group, or an ethyl group, R⁵ is a methyl group or an ethyl group; and a hydroxyalkyl (meth)acrylate monomer with an alkyl group having 2-4 carbon atoms (A5), and a hydrophobic monomer which is an alkyl (meth)acrylate with an alkyl group having 8-22 carbon atoms (B1) and/or vinyl ether with an alkyl group having 8-18 carbon atoms (B2) are copolymerized in a weight ratio of 2-40 parts by weight:60-98 parts by weight, in the preferred weight ratio of 2-20 parts by weight:80-98 parts by weight. The antifoaming agent is used by being blended into a nonaqueous coating agent of a thermo-setting type and/or a thermo-drying type in a small amount.

In the copolymerization product, when a content of the hydrophilic monomer (A1-A5) is 2-20 parts by weight, the antifoaming agent may be appropriately maintained incompatibility in paint. And by copolymerizing of the hydrophobic monomer (B1, B2 and the like) used to a conventional antifoaming agent for paint and the hydrophilic monomer (A1-A5) having comparatively-high polarity, the antifoaming agent has an amphiphilic structure. Thereby, self-dispersing performance of a polymer molecular is increased, and particles of the antifoaming agent as aggregates of polymers become smaller than particles of the conventional antifoaming agent, and are dispersed in the paint. Therefore, contact frequency to interfaces of bubbles and adsorption area thereto of the particles of the antifoaming agent are increased. Then, coalescence of the bubbles and bursts thereof at an outermost layer are facilitated further. It is inferred that the antifoaming agent has excellent effects of antifoaming and pinhole prevention. On the other hand, if the content of the hydrophilic monomer is less than 2 parts by weight, the effects on the basis of the amphiphilic structure is not fully exhibited, for example, compared with an antifoaming agent including a copolymerization product not containing the N-vinyl lactam structure, the tetrahydrofurfuryl structure, the structure represented by Formula (I), the structure represented by Formula (II), and/or the hydroxyalkyl structure. Therefore, the effects of the antifoaming and the pinhole prevention remain at the same level with the conventional antifoaming agent. Additionally, if the content of the hydrophilic monomer is more than 20 parts by weight, the polarity of the copolymerization product becomes high. Thereby, compatibility with the paint becomes high, and antifoaming performance and pinhole preventing performance are not merely exhibited but also decreased. The content of the hydrophilic monomer (A1-A5) is more preferably 4-10 parts by weight.

Also, in the copolymerization product, if the content of the hydrophobic monomer is less than 80 parts by weight, similarly in the above reasons, antifoaming performance and pinhole preventing performance may be not fully obtained. On the other hand, if the content of the hydrophobic monomer is more than 98 parts by weight, similarly in the antifoaming agent, based on conventional technology, including a copolymerization product not containing the N-vinyl lactam structure, the tetrahydrofurfuryl structure, the structure represented by Formula (I), the structure represented by Formula (II), and/or the hydroxyalkyl structure, improvement of the effects of the antifoaming and the pinhole prevention are not obtained by the similarly above reasons. The content of the hydrophobic monomer (B 1 and B2) is more preferably 90-96 parts by weight.

A weight-average molecular weight of the copolymerization product, in which these monomers are copolymerized, is 10,000-350,000. If the weight-average molecular weight thereof is less than 10,000, enough pinhole preventing performance is not obtained. On the other hand, if the weight-average molecular weight thereof is more than 350,000, in the case of adding the copolymerization product into a coating agent, compatibility of the copolymerization product with a resin in the coating agent is excessively decreased. Thereby, the coating agent becomes cloudy, dimples are generated to a surface of an applied film after applying the coating agent. The weight-average molecular weight of the copolymerization product is preferably 20,000-200,000.

R² in the (meth)acrylate monomer (A3) represented by Formula (I) is the hydrogen atom or the alkyl group having 1-4 carbon atoms. Specifically, the alkyl group having 1-4 carbon atoms includes a methyl group, an ethyl group, a n-propyl group, an isopropyl group, a n-butyl group, an isobutyl group and a tert-butyl group. These may be used either alone or conjunction, respectively.

The (meth)acryl amide monomer (A4) represented by Formula (II) includes, specifically, N-methyl (meth)acryl amide, N-ethyl (meth)acryl amide, N,N-dimethyl (meth)acryl amide, N,N-diethyl (meth)acryl amide. These may be used either alone or conjunction, respectively.

The hydroxyalkyl (meth)acrylate monomer with the alkyl group having 2-4 carbon atoms (A5) includes, specifically, 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate, 2-methyl-2-hydroxypropyl (meth)acrylate. These may be used either alone or conjunction, respectively.

Alkyl (meth)acrylate with the alkyl group having 8-22 carbon atoms (B1) is alkyl acrylate with the alkyl group having 8-22 carbon atoms or alkyl methacrylate with the alkyl group having 8-22 carbon atoms. Alkyl (meth)acrylate with the alkyl group having 8-22 carbon atoms (B1) includes, for example, n-octyl (meth)acrylate, 2-ethylhexyl (meth)acrylate, nonyl (meth)acrylate, isononyl (meth)acrylate, decyl (meth)acrylate, isodecyl (meth)acrylate, dodecyl (meth)acrylate, isododecyl (meth)acrylate, undecyl (meth)acrylate, isoundecyl (meth)acrylate, hexadecyl (meth)acrylate, isohexadecyl (meth)acrylate, octadecyl (meth)acrylate, isooctadecyl (meth)acrylate, behenyl (meth)acrylate and the like.

Vinyl ether with the alkyl group having 8-18 carbon atoms (B2) includes, for example, n-octyl vinyl ether, 2-ethylhexyl vinyl ether, isononyl vinyl ether, isodecyl vinyl ether, dodecyl vinyl ether, hexadecyl vinyl ether, octadecyl vinyl ether and the like.

In the copolymerization product, besides the hydrophilic monomer (A1-A5) and the hydrophobic monomer (B 1 and B2), a diluent monomer (C), which can be copolymerized with these, may be included and copolymerized.

The diluent monomer (C) is not especially restricted to its kind, may be copolymerized in the scope without deteriorating antifoaming performance and pinhole preventing performance of the antifoaming agent of the present invention. A specific content of the diluent monomer (C) is preferably within 30% by weight relative to a total weight of the hydrophilic monomer (A1-A5) and the hydrophobic monomer (B1 and B2).

The diluent monomer (C) includes, for example, a (meth)acrylic acid monomer such as acrylic acid and methacrylic acid; a (meth)acrylate monomer such as methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-amyl (meth)acrylate, isoamyl (meth)acrylate, hexyl (meth)acrylate, isohexyl (meth)acrylate, heptyl (meth)acrylate, isoheptyl (meth)acrylate, dimethylaminoethyl (meth)acrylate, diethylaminoethyl (meth)acrylate, benzyl (meth)acrylate, cyclohexyl (meth)acrylate, phenoxyethyl (meth)acrylate, isobornyl (meth)acrylate and glycidyl (meth)acrylate; (meth)acrylamides such as (meta)acrylamide, N-isopropyl (meth)acrylamide, diacetone (meth)acrylamide and (meth)acryloylmorpholine; an aromatic vinyl monomer such as styrene and vinyltoluene; a chained alkyl vinyl ether monomer having 1-7 carbon atoms or a cyclic alkyl vinyl ether monomer having 1-7 carbon atoms such as n-butyl vinyl ether, isobutyl vinyl ether, tert-butyl vinyl ether and cyclohexyl vinyl ether; a vinyl ester monomer such as vinyl acetate, vinyl propionate and vinyl laurate; a reaction product of a hydroxyl group-containing acrylic-type monomer and a lactone-group compound such as β-propiolactone, dimethylpropiolactone, butyrolactone, γ-valerolactone, γ-caprylolactone, γ-laurylolactone, ε-caprolactone and δ-caprolactone, and the like. Examples of the reaction product includes a lactone-modified (meth)acrylate monomer such as PLACCEL FM5, PLACCEL FM2D, PLACCEL FM3, PLACCEL FM1DDM, PLACCEL FA2D, PLACCEL FA10L (trade name, manufactured by Daicel Corporation) and the like as caprolactone-modified hydroxyl (meth)acrylate esters; ether group-containing alkyl (meth)acrylates such as polyethylene glycol (meth)acrylate ester (a degree of polymerization of ethylene glycol is 4-100), polypropylene glycol (meth)acrylate ester (a degree of polymerization of propylene glycol is 1-100), poly(ethylene-propylene)glycol (meth)acrylate ester (a degree of polymerization of ethylene glycol-propylene glycol is 1-100), poly(ethylene-tetramethylene)glycol (meth)acrylate ester (a degree of polymerization of ethylene glycol-tetramethylene glycol is 2-100), methoxypolyethylene glycol (meth)acrylate ester (a degree of polymerization of ethylene glycol is 4-100), methoxypolypropylene glycol (meth)acrylate ester (a degree of polymerization of propylene glycol is 1-100), methoxypoly(ethylene-propylene)glycol (meth)acrylate ester (a degree of polymerization of ethylene glycol-propylene glycol is 1-100), methoxypoly(ethylene-tetramethylene)glycol (meth)acrylate ester (a degree of polymerization of ethylene glycol-tetramethylene glycol is 1-100), butoxypoly(ethylene-propylene)glycol (meth)acrylate ester (a degree of polymerization of ethylene glycol-propylene glycol is 1-100), octoxypoly(ethylene-propylene)glycol (meth)acrylate ester (a degree of polymerization of ethylene glycol-propylene glycol is 1-100), lauloxypolyethylene glycol (meth)acrylate ester (a degree of polymerization of ethylene glycol is 1-100), stearoxypolyethylene glycol (meth)acrylate ester (a degree of polymerization of ethylene glycol is 1-100), phenoxypolyethylene glycol (meth)acrylate ester (a degree of polymerization of ethylene glycol is 1-100) and the like.

The antifoaming agent of the present invention may consist of these copolymerization products or alternatively may include these copolymerization products which are dissolved or suspended in an inactive solvent.

The preferred inactive solvent can dissolve or suspend the copolymerization product, and can mix to the coating agent. The inactive solvent includes concretely a hydrocarbon-type solvent such as xylene, toluene and cyclohexane; a ketone-type solvent such as cyclohexanone and methyl isobutyl ketone; an ether-type solvent such as methyl cellosolve, cellosolve, butyl cellosolve, methyl carbitol, carbitol, butyl carbitol, diethyl carbitol and propylene glycol monomethyl ether; a ester-type solvent such as n-butyl acetate, isobutyl acetate, n-amyl acetate, cellosolve acetate, propylene glycol monomethyl ether acetate and 3-methoxybutyl acetate; an alcohol-type solvent such as n-butanol, sec-butanol, isobutanol, cyclohexanol, 2-ethylhexanol and 3-methyl-3-methoxybutanol. These inactive solvents may be used alone or mixture of plurality.

Hereunder, a preparation example of the antifoaming agent of the present invention will be explained.

The hydrophilic monomer at least one selected from the group consisting of the N-vinyl lactam monomer (A1), the tetrahydrofurfuryl (meth)acrylate monomer (A2), the (meth)acrylate monomer represented by Formula (I) (A3), the (meth)acrylamide monomer represented by Formula (II) (A4) and the hydroxyalkyl (meth)acrylate monomer (A5) with the alkyl group having 2-4 carbon atoms; the hydrophobic monomer of allyl (meth)acrylate with the alkyl group having 8-22 carbon atoms (B 1) and/or vinyl ether with the alkyl group having 8-18 carbon atoms (B2); and the diluent monomer as needed are mixed. These monomers are polymerized in the presence of a polymerization initiator and furthermore a chain transfer agent as needed in a solvent. Thereby, the copolymerization product is synthesized, and the antifoaming agent is obtained. Furthermore, as necessary, the obtained copolymerization product and an inactive solvent may be mixed. Thereby, the antifoaming agent, in which the copolymerization product is dissolved or suspended in the inactive solvent, may be prepared.

The copolymerization product may be a random copolymer, a block copolymer or a graft copolymer.

A method of the polymerization may include, for example, a radical copolymerization and an anion copolymerization.

A solvent used in a polymerization reaction may include the exemplified solvent as the inactive solvent which dissolves or suspends the synthesized copolymerization product. The solvent may be appropriately selected from these solvent, and used.

The polymerization initiator used in the polymerization reaction may be appropriately selected corresponding to a kind of the used polymerization reaction. A radical polymerization initiator includes, for example, tert-butylperoxy-2-ethylhexanoate.

The obtained antifoaming agent is blended in a small amount into a nonaqueous coating constituent which forms a coating film by thermo-setting and/or thermo-drying. Thereby a nonaqueous coating agent, which is suppressed foaming, may be obtained. The nonaqueous coating agent, in which the antifoaming agent of the present invention is blended, exhibits antifoaming performance and pinhole preventing performance, and may improve leveling performance, cissing-preventing performance and wetting performance to a base material in some cases. Additionally, onto the applied film, which is formed by applying and curing or drying the nonaqueous coating agent on the base material, a coating agent of the same type or the different type therewith may be furthermore applied and cured or dried. Even in such the case, adhesion between layers is not different by existence or non-existence of the antifoaming agent.

The nonaqueous coating agent of the present invention, in which the antifoaming agent and the nonaqueous coating constituent are blended, may form the coating film by thermo-setting and/or thermo-drying. When a resin, which is contained in the nonaqueous coating constituent, cures through a cross-linking reaction by a heat treatment, the nonaqueous coating agent is referred to as a thermo-setting type. And when a solvent, which is contained therein, dries by the heat treatment, the nonaqueous coating agent is referred to as a thermo-drying type. The nonaqueous coating agent may form the coating film by curing the resin contained therein through the cross-linking reaction, or may form the coating film by drying the solvent contained therein, or may form the coating film by curing the resin through the cross-linking reaction along with drying of the solvent.

The nonaqueous coating agent may be prepared by mixing the antifoaming agent and the nonaqueous coating constituent in the same time or any order. For example, the antifoaming agent is blended into the preliminarily mixed nonaqueous coating constituent, and kneaded. Accordingly, the nonaqueous coating agent may be obtained.

In the nonaqueous coating agent, a content of the antifoaming agent is preferably 0.01-5% by weight, more preferably 0.05-1% by weight at a value converted into a solid content relative to total amount of the nonaqueous coating agent.

The nonaqueous coating constituent is not especially restricted. For example, the nonaqueous coating constituent includes a colorant such as pigment and dye, a resin, a diluent solvent, a catalyst and a surfactant. Additionally, as necessary, a sensitizer, an antistatic agent, a leveling agent, a base material-wetting agent, a cissing-preventing agent, a dispersant and a viscosity modifier may be blended into the nonaqueous coating agent.

When a resin which forms a curing film by accelerating the cross-linking reaction under high temperature is contained into the nonaqueous coating constituent, the thermo-setting type nonaqueous coating agent may be obtained. As a constituent of the resin, any resin used to general paints containing the thermo-setting resin such as an acrylic-melamine curing paint, an acid-epoxy curing paint, an acrylic-urethane and polyester-urethane curing paint produced by reaction of a hydroxyl group and an isocyanate group may be used. Alternatively, for example, when a cellulose nitrate lacquer or an acryl lacquer in the nonaqueous coating constituent, the thermo-drying type nonaqueous coating constituent which forms the coating film by drying the solvent through the heat treatment may be obtained.

A diluent solvent as the nonaqueous coating constituent is not restricted as long as it is an organic solvent of general use. The diluent solvent includes, for instance, a hydrocarbon-type solvent such as xylene, toluene and cyclohexane; a ketone-type solvent such as cyclohexanone and methyl isobutyl ketone; an ether-type solvent such as methyl cellosolve, cellosolve, butyl cellosolve, methyl carbitol, carbitol, butyl carbitol, diethyl carbitol and propylene glycol monomethyl ether; an ester-type solvent such as n-butyl acetate, isobutyl acetate, n-amyl acetate, cellosolve acetate, propylene glycol monomethyl ether acetate and 3-methoxybutyl acetate; an alcohol-type solvent such as n-butanol, sec-butanol, isobutanol, cyclohexanol, 2-ethylhexanol and 3-methyl-3-methoxybutanol. These solvents may be used alone, mixture of plurality, or further mixture with water.

The nonaqueous coating agent as the thermo-setting type and/or the thermo-drying type is applied on the base material, and then forms the applied film by thermo-setting and/or thermo-drying.

A baking temperature of the nonaqueous agent is not restricted as long as the constituent of the resin may produce the cross-linking Generally as the temperature which produces the cross-linking reaction a range of 120-280° C. is preferred. A drying temperature of the nonaqueous agent is not restricted as long as the solvent may be dried. In the case of forming the coating film by only drying the solvent, drying may be conducted at the comparatively-low temperature such as 60-120° C.

An applying method of the nonaqueous coating agent includes, for example, a spin coating method, a slit coating method, a spray coating method, a dip coating method, a bar coating method, a doctor blade method, a roll coating method and a flow coating method.

The applied film of the present invention is the coating film having a smooth surface by which the nonaqueous coating agent containing the antifoaming agent is cured or dried on the base material.

The base material is not especially restricted, for example, exterior materials of home electric appliances or automobiles, commodities and building materials, which are made of raw material such as plastics, rubber, paper, wood, glass, metal, stone, cement, mortar and ceramics, are included.

### EMBODIMENTS

Embodiments of the present invention will be described in detail below, but the scope of the present invention is not restricted to these embodiments.

Preparation Examples 1-10 show embodiments of preparing for antifoaming agents of the present invention, and Comparative Preparation Examples 1-9 show embodiments of preparing for antifoaming agents which are outside of the scope of the present invention.

### Preparation Example 1

100 parts by weight of cyclohexanone was added in a reaction vessel of 1,000 mL equipped a stirrer, a reflux condenser, a dropping funnel, a thermometer and a bubbling spout of nitrogen gas, and then it was heated until 110° C. under nitrogen gas atmosphere. The temperature of cyclohexanone was maintained at 110° C. A dropping solution (a-1) shown in below Table 1 was added dropwise using the dropping funnel for 2 hours at the constant dropping speed, to prepare a monomer solution. After dropping, the resultant monomer solution was heated until 120° C., and then it was reacted for 2 hours to synthesize a copolymerization product. Thereafter, it was diluted by cyclohexanone till concentration of residue thereof was 30% to prepare an antifoaming agent for a nonaqueous coating agent. The copolymerization product in the antifoaming agent was eluted with respect to each of molecular weight by the gel permeation chromatography which may isolate molecules having different molecular weight. Incidentally, a column was TSK-GEL SUPER MULTIPORE HZ-M (trade name), manufactured by TOSOH CORPORATION, and an eluting solvent was THF. The same was used hereafter. Thereby molecular weight distribution was determined. A calibration curve was ready drawn up from a standard material of polystyrene which certifies molecular weight respectively. The molecular weight distribution of the copolymer in the antifoaming agent was compared with the calibration curve. Accordingly, the weight-average molecular weight of the copolymerization product was obtained. In the result, the weight-average molecular weight of the copolymerization product in the antifoaming agent was 100,000 as a conversion value to the polystyrene.

### Preparation Example 2

An antifoaming agent for a nonaqueous coating agent of Preparation Example 2 was obtained in the same the manner as in Preparation Example 1 except that the dropping solution of (a-2) was used in place of the dropping solution of Preparation Example 1. The weight-average molecular weight of the copolymerization product in the antifoaming agent, which was determined by the gel permeation chromatography, was 50,000 as a conversion value to polystyrene.

### Preparation Example 3

An antifoaming agent for a nonaqueous coating agent of Preparation Example 3 was obtained in the same the manner as in Preparation Example 1 except that the dropping solution of (a-3) was used in place of the dropping solution of Preparation Example 1 and the temperature of dropping was 90° C. The weight-average molecular weight of the copolymerization product in the antifoaming agent, which was determined by the gel permeation chromatography, was 200,000 as a conversion value to polystyrene.

### Preparation Example 4

An antifoaming agent for a nonaqueous coating agent of Preparation Example 4 was obtained in the same the manner as in Preparation Example 1 except that the dropping solution of (a-4) was used in place of the dropping solution of Preparation Example 1 and the temperature of dropping was 120° C. The weight-average molecular weight of the copolymerization product in the antifoaming agent, which was determined by the gel permeation chromatography, was 60,000 as a conversion value to polystyrene.

### Preparation Example 5

An antifoaming agent for a nonaqueous coating agent of Preparation Example 5 was obtained in the same the manner as in Preparation Example 1 except that the dropping solution of (a-5) was used in place of the dropping solution of Preparation Example 1 and the temperature of dropping was 120° C. The weight-average molecular weight of the copolymerization product in the antifoaming agent, which was determined by the gel permeation chromatography, was 60,000 as a conversion value to polystyrene.

### Preparation Example 6

An antifoaming agent for a nonaqueous coating agent of Preparation Example 6 was obtained in the same the manner as in Preparation Example 1 except that the dropping solution of (a-6) was used in place of the dropping solution of Preparation Example 1. The weight-average molecular weight of the copolymerization product in the antifoaming agent, which was determined by the gel permeation chromatography, was 100,000 as a conversion value to polystyrene.

### Preparation Example 7

An antifoaming agent for a nonaqueous coating agent of Preparation Example 7 was obtained in the same the manner as in Preparation Example 1 except that the dropping solution of (a-7) was used in place of the dropping solution of Preparation Example 1. The weight-average molecular weight of the copolymerization product in the antifoaming agent, which was determined by the gel permeation chromatography, was 100,000 as a conversion value to polystyrene.

### Preparation Example 8

An antifoaming agent for a nonaqueous coating agent of Preparation Example 8 was obtained in the same the manner as in Preparation Example 1 except that the dropping solution of (a-8) was used in place of the dropping solution of Preparation Example 1. The weight-average molecular weight of the copolymerization product in the antifoaming agent, which was determined by the gel permeation chromatography, was 50,000 as a conversion value to polystyrene.

### Preparation Example 9

An antifoaming agent for a nonaqueous coating agent of Preparation Example 9 was obtained in the same the manner as in Preparation Example 1 except that the dropping solution of (a-9) was used in place of the dropping solution of Preparation Example 1. The weight-average molecular weight of the copolymerization product in the antifoaming agent, which was determined by the gel permeation chromatography, was 100,000 as a conversion value to polystyrene.

### Preparation Example 10

An antifoaming agent for a nonaqueous coating agent of Preparation Example 10 was obtained in the same the manner as in Preparation Example 1 except that the dropping solution of (a-10) was used in place of the dropping solution of Preparation Example 1. The weight-average molecular weight of the copolymerization product in the antifoaming agent, which was determined by the gel permeation chromatography, was 100,000 as a conversion value to polystyrene.

### Comparative Preparation Example 1

An antifoaming agent for a nonaqueous coating agent of Comparative Preparation Example 1 was obtained in the same the manner as in Preparation Example 1 except that the dropping solution of (b-1) was used in place of the dropping solution of Preparation Example 1. The weight-average molecular weight of the copolymerization product in the antifoaming agent, which was determined by the gel permeation chromatography, was 100,000 as a conversion value to polystyrene.

### Comparative Preparation Example 2

An antifoaming agent for a nonaqueous coating agent of Comparative Preparation Example 2 was obtained in the same the manner as in Preparation Example 1 except that the dropping solution of (b-2) was used in place of the dropping solution of Preparation Example 1. The weight-average molecular weight of the copolymerization product in the antifoaming agent, which was determined by the gel permeation chromatography, was 100,000 as a conversion value to polystyrene.

### Comparative Preparation Example 3

An antifoaming agent for a nonaqueous coating agent of Comparative Preparation Example 3 was obtained in the same the manner as in Preparation Example 1 except that the dropping solution of (b-3) was used in place of the dropping solution of Preparation Example 1 and the temperature of dropping was 100° C. The weight-average molecular weight of the copolymerization product in the antifoaming agent, which was determined by the gel permeation chromatography, was 100,000 as a conversion value to polystyrene.

### Comparative Preparation Example 4

An antifoaming agent for a nonaqueous coating agent of Comparative Preparation Example 4 was obtained in the same the manner as in Preparation Example 1 except that the dropping solution of (b-4) was used in place of the dropping solution of Preparation Example 1. The weight-average molecular weight of the copolymerization product in the antifoaming agent, which was determined by the gel permeation chromatography, was 100,000 as a conversion value to polystyrene.

### Comparative Preparation Example 5

An antifoaming agent for a nonaqueous coating agent of Comparative Preparation Example 5 was obtained in the same the manner as in Preparation Example 1 except that the dropping solution of (b-5) was used in place of the dropping solution of Preparation Example 1. The weight-average molecular weight of the copolymerization product in the antifoaming agent, which was determined by the gel permeation chromatography, was 50,000 as a conversion value to polystyrene.

### Comparative Preparation Example 6

An antifoaming agent for a nonaqueous coating agent of Comparative Preparation Example 6 was obtained in the same the manner as in Preparation Example 1 except that the dropping solution of (b-6) was used in place of the dropping solution of Preparation Example 1 and the temperature of dropping was 90° C. The weight-average molecular weight of the copolymerization product in the antifoaming agent, which was determined by the gel permeation chromatography, was 380,000 as a conversion value to polystyrene.

### Comparative Preparation Example 7

An antifoaming agent for a nonaqueous coating agent of Comparative Preparation Example 7 was obtained in the same the manner as in Preparation Example 1 except that the dropping solution of (b-7) was used in place of the dropping solution of Preparation Example 1 and the temperature of dropping was 125° C. The weight-average molecular weight of the copolymerization product in the antifoaming agent, which was determined by the gel permeation chromatography, was 8,000 as a conversion value to polystyrene.

### Comparative Preparation Example 8

An antifoaming agent for a nonaqueous coating agent of Comparative Preparation Example 8 was obtained in the same the manner as in Preparation Example 1 except that the dropping solution of (b-8) was used in place of the dropping solution of Preparation Example 1. The weight-average molecular weight of the copolymerization product in the antifoaming agent, which was determined by the gel permeation chromatography, was 100,000 as a conversion value to polystyrene.

### Comparative Preparation Example 9

An antifoaming agent for a nonaqueous coating agent of Comparative Preparation Example 9 was obtained in the same the manner as in Preparation Example 1 except that the dropping solution of (b-9) was used in place of the dropping solution of Preparation Example 1. The weight-average molecular weight of the copolymerization product in the antifoaming agent, which was determined by the gel permeation chromatography, was 50,000 as a conversion value to polystyrene.

Table 1 shows blended amounts of each ingredient in the dropping solution of Preparation Examples 1-10, and Table 2 shows blended amounts of each ingredient in the dropping solution of Comparative Preparation Examples 1-9. In the tables, a unit of numerical values is parts by weight.

TABLE 1

| | | Preparation Example | | | | | | | | | |
|---|---|---|---|---|---|---|---|---|---|---|---|
| | | 1 | 2 | 3 | 4 | 5 | 6 | 7 | 8 | 9 | 10 |
| Dropping solution | | a-1 | a-2 | a-3 | a-4 | a-5 | a-6 | a-7 | a-8 | a-9 | a-10 |
| Monomer | N-vinyl-2- | 20 | 20 | 20 | | | | | | | |
| (A1) | pyrrolidone | | | | | | | | | | |
| Monomer | Tetrahydrofurfuryl | | | | 10 | | | | | | |
| (A2) | acrylate | | | | | | | | | | |
| Monomer | Methoxytriethylene | | | | | 20 | | | | | |
| (A3) | glycol methacrylate | | | | | | | | | | |
| | Butoxydiethylene | | | | | | 20 | | | | |
| | glycol methacrylate | | | | | | | | | | |
| Monomer | N,N-dimethyl | | | | | | | 10 | | | |
| (A4) | acrylamide | | | | | | | | | | |
| | N,N-diethyl | | | | | | | | 20 | | |
| | acrylamide | | | | | | | | | | |
| Monomer | 2-Hydroxyethyl | | | | | | | | | 20 | |
| (A5) | methacrylate | | | | | | | | | | |
| | 4-Hydroxybutyl | | | | | | | | | | 10 |
| | acrylate | | | | | | | | | | |
| Monomer | Lauryl methacrylate | 180 | | | | | 90 | 80 | | 90 | 190 |
| (B1) | 2-Ethylhexyl | | 100 | 90 | 95 | 180 | | | 100 | | |
| | acrylate | | | | | | | | | | |
| | Stearyl methacrylate | | | | 95 | | | 50 | | 90 | |
| Monomer | Lauryl vinyl ether | | | 90 | | | 90 | | 80 | | |
| (B2) | Stearyl vinyl ether | | 80 | | | | | 50 | | | |
| Monomer | Benzyl methacrylate | | | | | | 40 | | | | 30 |
| (C) | n-Butyl acrylate | | | | | | | 40 | | | 30 |
| Inactive | Cyclohexanone | 100 | 100 | 100 | 100 | 100 | 100 | 100 | 100 | 100 | 100 |
| solvent | | | | | | | | | | | |
| Polymer- | tert-Butylperoxy-2- | 1 | 3 | 0.5 | 1 | 1 | 1 | 1 | 3 | 1 | 1 |
| ization | ethylhexanoate | | | | | | | | | | |
| initiator | | | | | | | | | | | |

TABLE 2

| | | Comparative Preparation Example | | | | | | | | |
|---|---|---|---|---|---|---|---|---|---|---|
| | | 1 | 2 | 3 | 4 | 5 | 6 | 7 | 8 | 9 |
| Dropping solution | | b-1 | b-2 | b-3 | b-4 | b-5 | b-6 | b-7 | b-8 | b-9 |
| Monomer | N-vinyl-2- | | 100 | | | | 20 | 20 | | |
| (A1) | pyrrolidone | | | | | | | | | |
| Monomer | Tetrahydrofurfuryl | | | | | 50 | | | | |
| (A2) | acrylate | | | | | | | | | |
| Monomer | Methoxytriethylene | | | 20 | | | | | | |
| (A3) | glycol methacrylate | | | | | | | | | |
| | Butoxydiethylene | | | | 60 | | | | | |
| | glycol methacrylate | | | | | | | | | |
| Monomer | N,N-dimethyl | | | | | | | | 80 | |
| (A4) | acrylamide | | | | | | | | | |
| | N,N-diethyl | | | | | | | | | |
| | acrylamide | | | | | | | | | |
| Monomer | 2-Hydroxyethyl | | | | | | | | | 20 |
| (A5) | methacrylate | | | | | | | | | |
| | 4-Hydroxybutyl | | | | | | | | | |
| | acrylate | | | | | | | | | |
| Monomer | Lauryl methacrylate | 200 | 50 | | | 80 | 180 | | | |
| (B1) | 2-Ethylhexyl | | | | 140 | | | 90 | | |
| | acrylate | | | | | | | | | |
| | Stearyl methacrylate | | | 90 | | | | | 60 | |
| Monomer | Lauryl vinyl ether | | 50 | 90 | | | | | | 180 |
| (B2) | Stearyl vinyl ether | | | | | 70 | | 90 | 60 | |
| Monomer | Benzyl methacrylate | | | | 40 | | | | 20 | 80 |
| (C) | n-Butyl acrylate | | | 80 | | | | | | |
| Inactive | Cyclohexanone | 100 | 100 | 100 | 100 | 100 | 100 | 100 | 100 | 100 |
| solvent | | | | | | | | | | |
| Polymer- | tert-Butylperoxy-2- | 1 | 1 | 1 | 1 | 2 | 0.2 | 10 | 1 | 2 |
| ization | ethylhexanoate | | | | | | | | | |
| initiator | | | | | | | | | | |

Examples 1-10 show embodiments of a nonaqueous coating agent and an applied film of the present invention using the antifoaming agents of Preparation Examples 1-10, and Comparative Examples 1-9 show embodiments of a nonaqueous coating agent and an applied film, which are outside of the scope of the present invention using the antifoaming agents of Comparative Prepared Examples 1-9.

### Example 1

56 parts by weight of an acrylic resin: ACRYDIC A-345 (manufactured by DIC Corporation. “ACRYDIC” is registered trade name of DIC Corporation), 14 parts by weight of a melamine resin: SUPER BECKAMINE (manufactured by DIC Corporation. “SUPER BECKAMINE” is registered trade name of DIC Corporation) and 30 parts by weight of a thinner which was mixed toluene and n-butanol in ratio of 4:1 by volume were kneaded by using a laboratory disperser at 2,000 rpm for 30 minutes to prepare acrylic-melamine curing clear paint. Viscosity of the acrylic-melamine curing clear paint at 25° C. was measured on the basis of a ford cup No. 4 method in conformity with Japanese Industrial Standards K-5400-4.5.4. According to the measurement method, fluidity of a sample may be evaluated. Particularly, a certain quantity sample is filled up to the specific cup having a hole with regulated diameter, and the sample is flowed from the hole. Then, efflux time of the sample from the hole is measured. The efflux time of the acrylic-melamine curing clear paint was approximately 18 seconds. The acrylic-melamine curing clear paint and 1.0 part by weight of the antifoaming agent of Preparation Example 1 were kneaded by using the laboratory disperser at 1,500 rpm for 3 minutes to prepare an acrylic-melamine coating agent as the nonaqueous coating agent.

### Examples 2-10 and Comparative Examples 1-9

Acrylic-melamine coating agents of Examples 2-10 and Comparative Examples 1-9 were prepared except that the antifoaming agents in Preparation Examples 2-10 and Comparative Examples 1-9 were used in place of the antifoaming agent in Example 1. Each physical and chemical evaluation was conducted relative to the obtained acrylic-melamine coating agents in Examples 1-10 and Comparative Examples 1-9, respectively. The physical and chemical evaluation was an antifoaming evaluation, a pinhole preventing evaluation and a film appearance evaluation.

### (Antifoaming Evaluation)

The antifoaming evaluation was conducted as follows. The acrylic-melamine curing clear paint, which was not added the antifoaming agent and was left to stand at a half-day, was poured into Harvard type specific gravity bottle of 25 mL. Then, weight of the acrylic-melamine curing clear paint which was filled thereto was measured. Each of the coating agent, which was prepared in Examples 1-10 and Comparative Examples 1-9 respectively, was partly poured into Harvard type specific gravity bottle of 25 mL after being left to stand at 1 minute. Thereafter, weight of the coating agent which was filled thereto was measured. When a weight thereof before kneading was defined as 100%, a ratio of the weight after kneading was expressed in percentage. Thereby, antifoaming performance was evaluated. When antifoaming performance was poor, the coating agent included foams. Therefore, the ratio became small. The results of evaluation were classified by 3 grades according to definition that 98% or more was “Excellent”, 94% or more and less than 98% was “Good”, and less than 94% was “Poor”.

### (Pinhole Preventing Evaluation)

Each of the coating agent was sprayed and applied with gradation onto an aluminum plate having the size of 280 cm×95 cm×0.3 mm by using an air spray having 1.0 mm of a bore and 3.5 kg/cm² of discharge pressure under conditions of temperature of 25° C. and humidity of 70% so as to gradate the thickness thereof. After applying, it was immediately baked in a hot-air cyclic type baking furnace at 140° C. for 20 minutes. Thereby, an applied film for the pinhole evaluation which was cured was formed. A minimum film thickness which generated pinholes, namely, a pinhole limit film thickness of the cured applied film was measured by using a magnetic inductive type coating thickness meter (trade name: SWT-8000, manufactured by SANKO ELECTRONIC LABORATORY CO., LTD.). Thereby, the effect of the antifoaming agent for the coating agent was evaluated. The results of evaluation were classified by 3 grades according to definition that 40 μm or more of the pinhole limit film thickness was “Excellent”, 30 μm or more and less than 40 μm thereof was “Good”, and less than 30 μm thereof was “Poor”.

### (Film Appearance Evaluation)

In the film appearance evaluation, the appearance of the cured applied film of Examples 1-10 and Comparative Examples 1-9, which was obtained in the pinhole preventing evaluation, was visually observed, respectively. The results of evaluation were classified by 2 grades according to definition that the film appearance with smoothness and without dimples was “Excellent” and the film appearance with dimples and poor smoothness was “Poor”.

The obtained results by conducting each evaluation of Examples 1-10 and Comparative Examples 1-9 were shown in Table 3.

TABLE 3

| | | Antifoaming performance | | Pinhole preventing performance | | |
|---|---|---|---|---|---|---|
| | Antifoaming | Weight | | Pinhole limit film | | Film |
| | agent | ratio (%) | Evaluation | thickness (μm) | Evaluation | appearance |
| Example 1 | Preparation | 99.0 | Excellent | 50 | Excellent | Excellent |
| | Example 1 | | | | | |
| Example 2 | Preparation | 99.2 | Excellent | 45 | Excellent | Excellent |
| | Example 2 | | | | | |
| Example 3 | Preparation | 98.4 | Excellent | 55 | Excellent | Excellent |
| | Example 3 | | | | | |
| Example 4 | Preparation | 98.7 | Excellent | 50 | Excellent | Excellent |
| | Example 4 | | | | | |
| Example 5 | Preparation | 98.8 | Excellent | 50 | Excellent | Excellent |
| | Example 5 | | | | | |
| Example 6 | Preparation | 99.0 | Excellent | 45 | Excellent | Excellent |
| | Example 6 | | | | | |
| Example 7 | Preparation | 98.8 | Excellent | 50 | Excellent | Excellent |
| | Example 7 | | | | | |
| Example 8 | Preparation | 98.5 | Excellent | 50 | Excellent | Excellent |
| | Example 8 | | | | | |
| Example 9 | Preparation | 99.3 | Excellent | 55 | Excellent | Excellent |
| | Example 9 | | | | | |
| Example 10 | Preparation | 98.9 | Excellent | 50 | Excellent | Excellent |
| | Example 10 | | | | | |
| Comparative | Comparative | 99.6 | Excellent | 35 | Good | Excellent |
| Example 1 | Preparation | | | | | |
| | Example 1 | | | | | |
| Comparative | Comparative | 89.9 | Poor | 25 | Poor | Excellent |
| Example 2 | Preparation | | | | | |
| | Example 2 | | | | | |
| Comparative | Comparative | 97.2 | Good | 30 | Good | Excellent |
| Example 3 | Preparation | | | | | |
| | Example 3 | | | | | |
| Comparative | Comparative | 95.5 | Good | 25 | Poor | Excellent |
| Example 4 | Preparation | | | | | |
| | Example 4 | | | | | |
| Comparative | Comparative | 96.5 | Good | 30 | Good | Excellent |
| Example 5 | Preparation | | | | | |
| | Example 5 | | | | | |
| Comparative | Comparative | 96.6 | Good | 30 | Good | Poor |
| Example 6 | Preparation | | | | | |
| | Example 6 | | | | | |
| Comparative | Comparative | 94.8 | Good | 30 | Good | Excellent |
| Example 7 | Preparation | | | | | |
| | Example 7 | | | | | |
| Comparative | Comparative | 91.2 | Poor | 25 | Poor | Excellent |
| Example 8 | Preparation | | | | | |
| | Example 8 | | | | | |
| Comparative | Comparative | 90.4 | Poor | 25 | Poor | Excellent |
| Example 9 | Preparation | | | | | |
| | Example 9 | | | | | |

According to Table 3, it is obvious that the nonaqueous coating agent of Examples 1-10 was excellent in the all evaluations. It is also obvious that the coating agent of Comparative Examples 1-9 was insufficient any one of the evaluations compared with the nonaqueous agent of Examples 1-10.

### INDUSTRIAL APPLICABILITY

The antifoaming agent of the present invention may be used by adding into a composition which forms a coating film by thermo-setting and/or thermo-drying, which coats a surface of: plastic materials such as the housing for the home electric appliance; metal materials such as pre-coat metals which are processed by cutting after applying; wall materials such as building materials; and bodies of automobiles.

1. An antifoaming agent for a nonaqueous coating agent comprising:
a copolymerization product having a weight-average molecular weight of 10,000-350,000, is copolymerized with;
2-40 parts by weight of a hydrophilic monomer at least one selected from the group consisting of: an N-vinyl lactam monomer; a tetrahydrofurfuryl (meth)acrylate monomer; a (meth)acrylate monomer represented by following Formula (I): 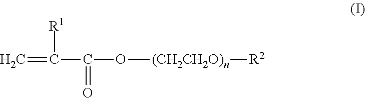
in Formula (I); R¹ is a hydrogen atom or a methyl group, R² is a hydrogen atom or an alkyl group having 1-4 carbon atoms, and n is a positive number of 2-3; a (meth)acrylamide monomer represented by following Formula (II): 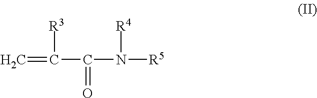
in Formula (II); R³ is a hydrogen atom or a methyl group, R⁴ is a hydrogen atom, a methyl group; or an ethyl group, R⁵ is a methyl group or an ethyl group; and a hydroxyalkyl (meth)acrylate monomer with an alkyl group having 2-4 carbon atoms, and
60-98 parts by weight of a hydrophobic monomer of an alkyl (meth)acrylate with an alkyl group having 8-22 carbon atoms and/or vinyl ether with an alkyl group having 8-18 carbon atoms.

2. The antifoaming agent for the nonaqueous coating agent according to claim 1, wherein the hydrophilic monomer is:
the N-vinyl lactam monomer at least one selected from the group consisting of N-vinyl-2-pyrrolidone and N-vinyl-ε-caprolactam;
the (meth)acrylate monomer represented by Formula (I) whose R² is a methyl group, an ethyl group, a n-propyl group, an isopropyl group, a n-butyl group, an isobutyl group and/or a tert-butyl group;
the (meth)acrylamide monomer at least one selected from the group consisting of N-methyl (meth)acrylamide, N-ethyl (meth)acrylamide, N,N-dimethyl (meth)acrylamide, and N,N-diethyl (meth)acrylamide; and/or
the hydroxyalkyl (meth)acrylate monomer at least one selected from the group consisting of 2-hydroxyethyl (meth)acrylate, 2-hydroxypropyl (meth)acrylate, 3-hydroxypropyl (meth)acrylate, 2-hydroxybuthyl (meth)acrylate, 3-hydroxybuthyl (meth)acrylate, 4-hydroxybuthyl (meth)acrylate, and 2-methyl-2-hydroxy propyl (meth)acrylate.

3. A nonaqueous coating agent comprising the antifoaming agent according to claim 1 and a nonaqueous coating constituent.

4. An applied film being formed by applying the nonaqueous coating agent according to claim 3.
